(19) United States
(12) Patent Application Publication
(10) Pub. No.: US 2003/0030848 A1
(43) Pub. Date: Feb. 13, 2003

(54) Facsimile device and control method thereof

(75) Inventor: Masatoshi Inoue, Kanagawa (JP)

Correspondence Address: RICHARD F. JAWORSKI, Cooper & Dunham LLP, 1185 Avenue of the Americas, New York, NY, 10036, US

(73) Assignee: Ricoh Company, Ltd.

(21) Appl. No.: 10/197,314

(22) Filed: Jul. 16, 2002

(30) Foreign Application Priority Data
Jul. 18, 2001 (JP) 2001-217874

(51) Int. Cl. H04N 1/00

(52) U.S. Cl. 358/402; 358/440

(57) ABSTRACT

The control method of the facsimile device according to the present invention comprises the steps of extracting a character sequence representing an e-mail address from the contents of the received e-mail, extracting a character sequence representing a name of the origin of the received e-mail for extracted e-mail address, storing both the e-mail address and the name of the origin of the received e-mail as a destination name in the system memory, and associating a pair of e-mail address and corresponding destination name with one of a plurality of one-touch dial buttons. Therefore, when there are an e-mail address and a destination name indicated in the contents of the received e-mail, the e-mail address and the destination name are automatically extracted and stored in the memory.

### BACKGROUND OF THE INVENTION

1. Field of the Invention

The present invention generally relates to a facsimile device and a control method of the facsimile device, and in particular to a facsimile device adapted for use in a communication network so as to receive and send an electronic mail (e-mail) via the communication network and a control method of such facsimile device.

2. Description of the Related Art

Recently, an increasing number of facsimile devices adapted to networks in order to realize their multi-functionality are being developed. One of the functions to be realized by such facsimile devices is to provide, for example, a function of receiving and sending e-mails. However, in such function of receiving and sending e-mails of such facsimile devices, there is a disadvantage that even when an e-mail address is indicated in the contents of the received e-mail (in the message portion of the received e-mail), such e-mail address cannot be effectively utilized.

In other words, even when the e-mail address is indicated in the contents of the received e-mail, in order to send a new e-mail or a return e-mail to the indicated e-mail address, it is either necessary to store the e-mail address and then perform new address registration or to copy the e-mail address in the contents and then paste the relevant e-mail address in a field designated for the destination e-mail address in an e-mail creation screen when sending an e-mail to the relevant e-mail address.

### SUMMARY OF THE INVENTION

Accordingly, it is a general object of the present invention to provide a facsimile device and a control method of the facsimile device that facilitate registration of an e-mail address indicated in the received e-mail, as well as to realize a simple sending of e-mails to the registered e-mail address.

In order to achieve the above-mentioned object, according to one aspect of the present invention, there is proposed a facsimile device provided with a function of receiving and sending an e-mail. The facsimile device according to the present invention comprises an electronic mail address extraction means for extracting a character sequence representing an electronic mail address from the contents of the e-mail received through a communication line and storage means for storing the character sequence representing the e-mail address extracted by the electronic mail address extraction means.

According to another aspect of the present invention, the facsimile device further comprises a display means for displaying a group of e-mail addresses stored in the storage means and a selection means for selecting a desired e-mail address from the group of e-mail addresses displayed by the display means. The display means then displays an e-mail creation screen with the selected e-mail address provided thereon.

According to another aspect of the present invention, the facsimile device further comprises an origin name extraction means for extracting a character sequence representing a name of the origin of the e-mail from the contents of the e-mail received. The storage means stores the extracted character sequence representing the name of the origin of the e-mail, as a destination name, and the stored extracted character sequence representing the electric mail address being associated thereto.

According to another aspect of the present invention, the facsimile device further comprises a display means for displaying the group of e-mail addresses as well as the destination names associated with the respective e-mail addresses, both stored in the storage means, and a selection means for selecting a desired e-mail address from the group of e-mail addresses and a corresponding destination name associated with the desired e-mail address. The display means then displays an electronic mail creation screen with the selected electronic mail address provided thereon.

According to another aspect of the present invention, the display means displays the destination name with respect to each e-mail address.

According to another aspect of the present invention, the facsimile device further comprises a registration means for registering a pair of the e-mail address and the destination name associated with the e-mail address, both stored in the storage means, to one of a plurality of simple selection buttons. By detecting depression of the one of the plurality of simple selection buttons, information of said pair of the e-mail address and the destination name associated with the e-mail address corresponding to the depressed button is read out and the e-mail creation screen with the pair provided thereon is displayed.

According to a further aspect of the present invention, there is provided a method of controlling the facsimile device provided with a function of receiving and sending an e-mail. The method according to the present invention comprises the steps of extracting a character sequence representing an electronic mail address from the contents of the e-mail received through a communication line and storing the character sequence representing the e-mail address extracted in the extraction step.

According to a further aspect of the present invention, the method further comprises the steps of displaying a group of e-mail addresses stored in the storing step, selecting a desired e-mail address from said group of e-mail addresses displayed in the displaying step, and displaying an e-mail creation screen with the selected e-mail address provided thereon.

According to a further aspect of the present invention, the method further comprises the step of extracting a character sequence representing a name of the origin of the e-mail from the contents of the received e-mail, wherein during the storing step, the extracted character sequence representing the name of the origin of the e-mail is stored as a destination name and the stored extracted character sequence representing the e-mail address being associated.

According to a further aspect of the present invention, the method further comprises the steps of displaying a group of e-mail addresses as well as the destination names associated with respective e-mail addresses stored in the storing step, selecting a desired e-mail address from the group of e-mail addresses and a corresponding destination name associated with the desired e-mail address, and displaying an e-mail creation screen with the selected e-mail address and the selected destination name associated with the selected e-mail address provided thereon.

According to a further aspect of the present invention, in the step of displaying the group of e-mail addresses as well as the destination names associated with the respective e-mail addresses stored in the storing step, the destination name is displayed with respect to each e-mail address.

According to a further aspect of the present invention, the method further comprises the steps of registering a pair of the e-mail address and the destination name associated with the e-mail address, both stored in the storing step, to one of a plurality of simple selection buttons, detecting depression of the one of the plurality of simple selection buttons, reading out the information of the pair of the e-mail address and the destination name associated with the e-mail address corresponding to the depressed button, and displaying the e-mail creation screen with the pair provided thereon.

It is noted that according to the present invention, the facsimile device and the control method thereof are enabled to extract a character sequence representing the e-mail address from the contents of the received e-mail and store the extracted e-mail address for later use. Therefore, a user can simply select one of the extracted e-mail addresses to be used as the destination address for the e-mail to be sent, obviating the possibility of erroneous inputs by the user manually typing the relevant e-mail address.

In addition, according to the present invention, the facsimile device and the control method thereof allow user-friendliness of the facsimile device when selecting the e-mail destination address to be improved by associating the extracted e-mail address with the destination name.

Further, according to the present invention, the facsimile device and the control method thereof allow the user-friendliness of the facsimile device when selecting the e-mail address to be further improved by associating the pair comprising the e-mail address and the destination name with one of the one-touch dial buttons.

The facsimile device and the control method of the facsimile device according to the present invention will be described in detail by making reference to the accompanying drawings.

### BRIEF DESCRIPTION OF THE DRAWINGS

FIG. 1 is a block diagram illustrating a schematic configuration of the facsimile device in one embodiment of the present invention;

FIG. 2 is a flow chart indicating a first operational flow of the facsimile device according to the embodiment of the present invention; and

FIG. 3 is a flow chart indicating a second operational flow of the facsimile device according to the embodiment of the present invention.

### DETAILED DESCRIPTION OF THE PREFERRED EMBODIMENTS

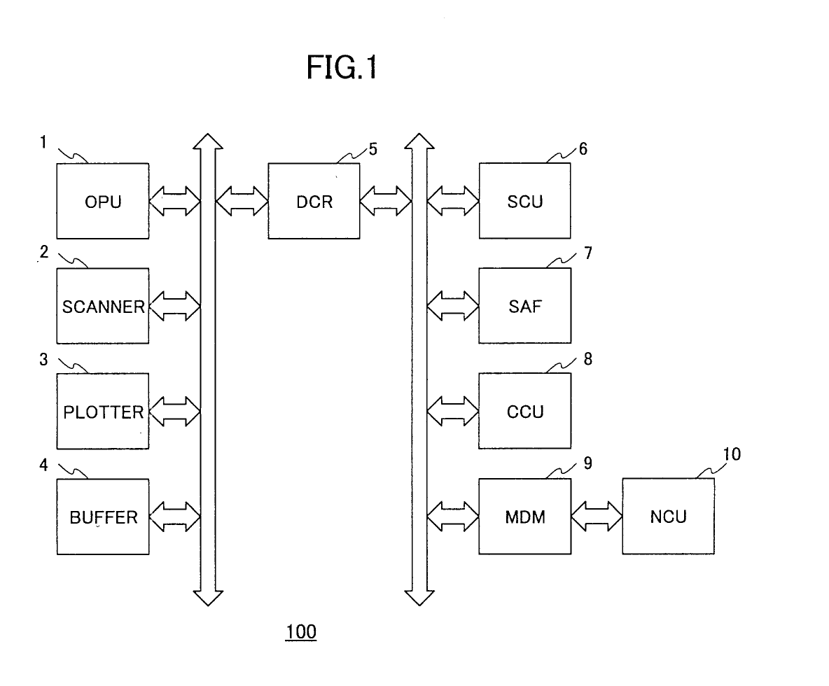

FIG. 1 through FIG. 3 represent an embodiment of the facsimile device and the control method thereof according to the present invention.

FIG. 1 is a block diagram illustrating a schematic configuration of the facsimile device in the preferred embodiment of the present invention. In FIG. 1, the facsimile device 100 according the present invention includes an operation panel control unit (OPU) 1, a scanner 2, a plotter 3, a buffer 4, a data compression re-construction unit (DCR) 5, a system control unit (SCU) 6, an image accumulation unit (SAF memory) 7, a communication control unit (CCU) 8, a modem (MDM) 9, and a network control unit (NCU) 10.

The operation panel control unit 1 is, for example, a liquid crystal display (LCD) displaying an e-mail address and is equipped with a plurality of one-touch dial buttons, etc. The scanner 2 reads out image information (such as text, etc.). The plotter 3 prints the received text on a recording paper. The buffer 4 serves as an intermediate buffer when interacting with the peripheral devices. The data compression reconstruction unit 5 compresses and expands the image information.

The system control unit 6 is equipped with a CPU and a main memory and is responsible for the overall operation of the facsimile device 100. The system control unit 6 not only interprets operational information, etc., input via the operation panel control unit 1, but also controls display information (such as guidance information or address information) to be displayed on the operation panel control unit 1. The system control unit 6 also serves as a system memory storing the e-mail addresses and destination names.

The image accumulation unit 7 serves as a SAF memory that accumulates the image information as a file. The communication control unit 8 controls communication of the facsimile device 100. The modem 9 has a function of a FAX modem that performs a usual facsimile receiving and sending and a function of a data communication modem that performs data (such as e-mail, etc.) communication. The network control unit 10 is connected to the communication line and not only checks the connection/disconnection states of the line but also is responsible for connection/disconnection to the Internet according to a switching signal from the communication control unit 8.

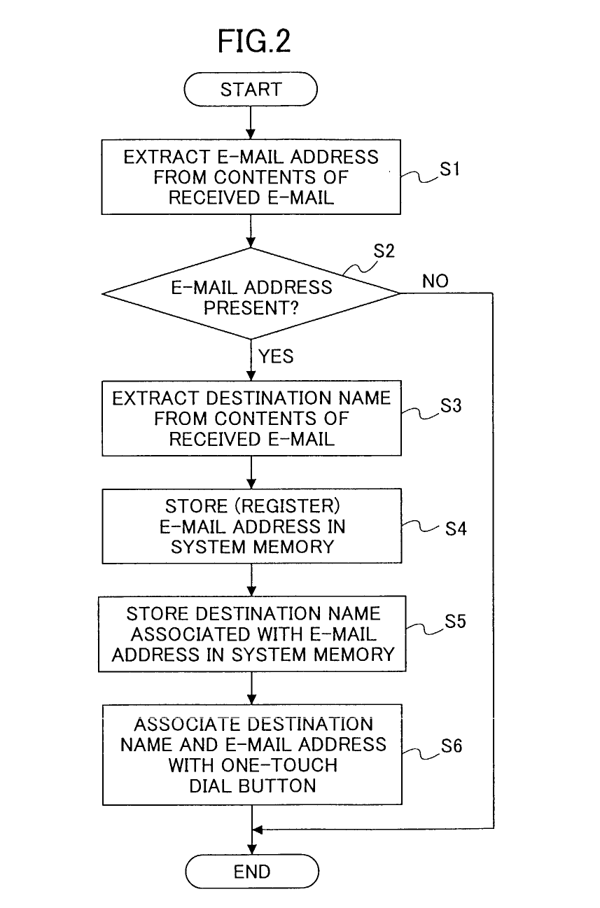

FIG. 2 is a flow chart indicating a first operational flow of the facsimile device according to the embodiment of the present invention. An automatic registration process of an e-mail address in the contents of the received e-mail is illustrated based on FIG. 2.

In step S1, an e-mail address is extracted from the contents of the received e-mail. The extraction of the e-mail address is performed, for example, based on the presence or absence of an alphanumeric sequence representing a user name before an at-mark (@) and an alphanumeric sequence representing a domain name for organizations and/or countries separated by a period (.) after the at-mark (in the case of Japan, an alphanumeric sequence representing a domain name is, for example, “co.jp”). In case there is no alphanumeric sequence representing an e-mail address, then the process ends (step S2-NO).

In case there is an alphanumeric sequence representing an e-mail address in the contents of the received e-mail (step S2-YES), an alphanumeric sequence representing a name of the origin of the e-mail is extracted from the contents of the received e-mail (step S3). The extraction of the name of the origin of the received e-mail is performed using a method of extracting the portion in the contents of the received e-mail that is enclosed by quotation marks such as “. . . ” or a method of extracting an alphanumeric sequence representing a single word following the e-mail address. It is noted that in these methods of extracting, the name of the origin of the received e-mail may be arranged in advance as a destination name for the extracted e-mail address and may be registered in the facsimile device. When there is no alphanumeric sequence representing the destination name, the process simply carries on.

In step S4, the e-mail address extracted in step S1 is stored (registered) in a system memory (nonvolatile memory) of the system control unit 6. In addition, in step S5, the destination name extracted in step S3 is associated with the e-mail address and then registered in the system memory of the system control unit 6. It is noted that when there is no destination name extracted, only the e-mail address is stored in the system memory.

In step S6, the e-mail address (and the destination name) stored in the system memory of the system control unit 6 are associated with one of the plurality of one-touch dial buttons (simple selection buttons) provided on the operation panel control unit of the facsimile device of the present invention.

According to the first operational flow of the facsimile device of the present invention, when the e-mail address is indicated in the contents of the received e-mail, it is possible to automatically extract the e-mail address (and the destination name) and register it in the memory.

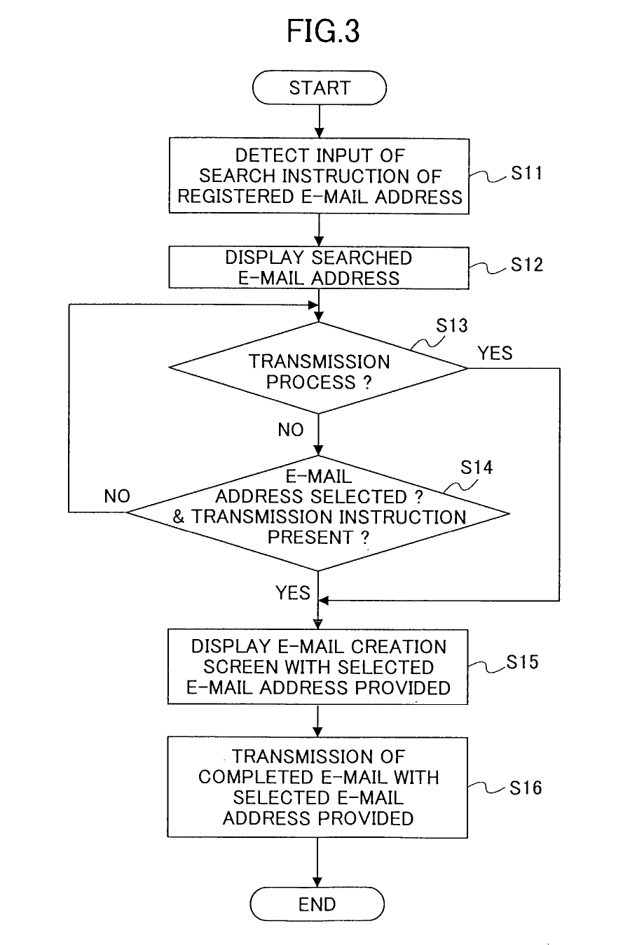

FIG. 3 is a flow chart indicating a second operational flow of the facsimile device according to the embodiment of the present invention. A display process of the registered e-mail address is illustrated based on FIG. 3.

In step S11, an input of a search instruction by a user through the operation panel control unit 1 comprised of an LCD, etc., is detected. The detection as mentioned herein means to detect an input of the selection instruction of a desired e-mail address among a plurality of e-mail addresses registered in the system memory or a depression of the one-touch dial button associated with one of the e-mail addresses registered in the system memory, wherein the input of the selection instruction and the depression of the button are performed by the user manipulating the buttons on the operation panel control unit following the guidance information presented on the LCD.

When the input of the search instruction is detected in step S11, the selected e-mail address or the e-mail address associated with the one-touch dial button is read out from the system memory of the system control unit 6 and is displayed on the operation panel control unit 1 (step S12).

In step S13, it is determined whether a transmission process for the e-mail address displayed on the operation panel control unit 1 is to be carried out. The transmission process includes such as scanning a manuscript and determining presence of a transmission instruction. When it is determined that the transmission process is to be carried out (step S13-YES), then an e-mail creation screen with the selected e-mail address provided thereon as the destination e-mail address is displayed (step S15). After completing the creation of the e-mail to be sent, the relevant e-mail is transmitted to the relevant e-mail address, in other words, the transmission process is completed (step S16).

When it is determined that the transmission process is not to be carried out (step S13-NO), the selection of e-mail address is confirmed and the presence of the transmission instruction for the selected e-mail address is determined. When there is no transmission instruction (step S14-NO), the process returns to step S13.

When the selected e-mail address is confirmed and there is a transmission instruction for the relevant e-mail address (step S14-YES), the e-mail creation screen with the selected e-mail address provided thereon as the destination e-mail address is displayed (step S15) and after the completing of the creation of the e-mail to be sent, the relevant e-mail is transmitted to the relevant e-mail address, in other words, the transmission process is completed (step S16).

According to the second operational flow of the present invention, the e-mail creation screen with the e-mail address selected by the selection instruction through the operation panel control unit from a group of e-mail addresses registered in the system memory or with the e-mail address associated with the one-touch dial button already provided thereon is displayed as a pop-up screen. Thus, the user need not manually input the e-mail address and therefore it is possible to obviate the possibility of erroneous inputs.

Further, the present invention is not limited to these embodiments, and variations and modifications may be made without departing from the scope of the present invention.

The present application is based on Japanese priority application No. 2001-217874 filed on Jul. 18, 2001, the entire contents of which are hereby incorporated by reference.

What is claimed is:

1. A facsimile device provided with a receiving member connectable to a communication line for receiving an electronic mail and a sending member for sending an electronic mail comprising:
an electronic mail address extraction member connected to the receiving member for extracting a character sequence representing an electronic mail address from contents of the received electronic mail; and
a storage member connected to the electronic mail address extraction member for storing said character sequence extracted by said electronic mail address extraction member.

2. The facsimile device as claimed in claim 1, said device further comprising:
a display member connected to said storage member for displaying a group of electronic mail addresses stored in said storage member; and
a selection member for selecting a desired electronic mail address from said group of electronic mail addresses displayed by said display member,
wherein said display member displays an electronic mail creation screen with said selected electronic mail address provided thereon.

3. The facsimile device as claimed in claim 1, said device further comprising;
an origin name extraction member connected to both said receiving member and said storage member for extracting a character sequence representing a name of the origin of the electronic mail from the contents of the received electronic mail,
wherein said storage member stores said extracted character sequence representing the name of the origin of the electronic mail as a destination name and said stored extracted character sequence representing the electronic mail address being associated thereto.

4. The facsimile device as claimed in claim 3, said device further comprising:
a display member connected to said storage member for displaying a group of electronic mail addresses as well as the destination names associated therewith, both stored in said storage member; and
a selection member for selecting a desired electronic mail address from said group of electronic mail addresses and a corresponding destination name associated therewith,
wherein said display member displays an electronic mail creation screen with said selected electronic mail address and said selected destination name associated therewith provided thereon.

5. The facsimile device as claimed in claim 4, wherein said display member displays said destination name with respect to each electronic mail address.

6. The facsimile device as claimed in claim 5, said device further comprising:
a registration member connected to said storage member for registering a pair of said electronic mail address and said destination name associated therewith, both stored in said storage member, to one of a plurality of simple selection buttons,
wherein by detecting depression of said one of the plurality of simple selection buttons, information of said pair of said electronic mail address and said destination name associated therewith corresponding to said depressed simple selection button is read out and said electronic mail creation screen with said pair provided thereon is displayed.

7. A facsimile device provided with a function of receiving and sending an electronic mail comprising:
an electronic mail address extraction means for extracting a character sequence representing an electronic mail address from contents of the electronic mail received through a communication line; and
a storage means for storing said character sequence extracted by said electronic mail address extraction member.

8. The facsimile device as claimed in claim 7, said device further comprising:
a display means for displaying a group of electronic mail addresses stored in said storage means; and
a selection means for selecting a desired electronic mail address from said group of electronic mail addresses displayed by said display means,
wherein said display means displays an electronic mail creation screen with said selected electronic mail address provided thereon.

9. The facsimile device as claimed in claim 7, said device further comprising;
an origin name extraction means for extracting a character sequence representing a name of the origin of the electronic mail from the contents of the received electronic mail,
wherein said storage means stores said extracted character sequence representing the name of the origin of the electronic mail as a destination name and said stored extracted character sequence representing the electronic mail address being associated thereto.

10. The facsimile device as claimed in claim 9, said device further comprising:
a display means for displaying a group of electronic mail addresses as well as the destination names associated therewith, both stored in said storage means; and
a selection means for selecting a desired electronic mail address from said group of electronic mail addresses and a corresponding destination name associated therewith,
wherein said display means displays an electronic mail creation screen with said selected electronic mail address and said selected destination name associated therewith provided thereon.

11. The facsimile device as claimed in claim 10, wherein said display means displays said destination name with respect to each electronic mail address.

12. The facsimile device as claimed in claim 11, said device further comprising:
a registration means for registering a pair of said electronic mail address and said destination name associated therewith, both stored in said storage means, to one of a plurality of simple selection buttons,
wherein by detecting depression of said one of the plurality of simple selection buttons, information of said pair of said electronic mail address and said destination name associated therewith corresponding to said depressed simple selection button is read out and said electronic mail creation screen with said pair provided thereon is displayed.

13. A method of controlling a facsimile device provided with a function of receiving and sending an electronic mail, said method comprising the steps of:
extracting a character sequence representing an electronic mail address from contents of the electronic mail received through a communication line; and
storing said character sequence extracted in said extraction step.

14. The method as claimed in claim 13, said method further comprising the steps of:
displaying a group of electronic mail addresses stored in said storing step;
selecting a desired electronic mail address from said group of electronic mail addresses displayed in said displaying step; and
displaying an electronic mail creation screen with said selected electronic mail address provided thereon.

15. The method as claimed in claim 13, said method further comprising the step of:
extracting a character sequence representing a name of the origin the electronic mail from the contents of the received electronic mail,
wherein during said storing step, said extracted character sequence representing the name of the origin of the electronic mail is stored as a destination name and said stored extracted character sequence representing the electronic mail address is associated thereto.

16. The method as claimed in claim 15, said method further comprising the steps of:
displaying a group of electronic mail addresses as well as the destination names associated therewith, both stored in said storing step;
selecting a desired electronic mail address from said group of electronic mail addresses and a corresponding destination name associated therewith; and
displaying an electronic mail creation screen with said selected electronic mail address and said selected destination name associated therewith provided thereon.

17. The method as claimed in claim 16, wherein said step of displaying said group of electronic mail addresses as well as the destination names associated with the respective electronic mail addresses stored in said storing step, said destination name is displayed with respect to each electronic mail address.

18. The method as claimed in claim 17, said method further comprising the steps of:
registering a pair of said electronic mail address and said destination name associated therewith, both stored in said storing step, to one of a plurality of simple selection buttons;
detecting depression of said one of the plurality of simple selection buttons;
reading out information of said pair of said electronic mail address and said destination name associated therewith corresponding to said depressed simple selection button; and
displaying said electronic mail creation screen with said pair provided thereon.
